(19) United States
(12) Patent Application Publication
(10) Pub. No.: US 2026/0012401 A1
(43) Pub. Date: Jan. 8, 2026

(54) SYSTEM AND METHOD FOR VISUALIZING KEY METRICS OF WIRELESS NODES

(71) Applicant: JIO PLATFORMS LIMITED, Ahmedabad, Gujarat (IN)

(72) Inventors: Aayush BHATNAGAR, Navi Mumbai, Maharashtra (IN); Pradeep Kumar BHATNAGAR, Navi Mumbai, Maharashtra (IN); Sundaresh SANKARAN, Mumbai, Maharashtra (IN); Haresh B. AMBALIYA, Bhundani, Gujarat (IN); Farsana CS, Thrissur, Kerala (IN); Mandar PATIL, Mumbai, Maharashtra (IN); Vikram SINGH, Navi Mumbai, Maharashtra (IN)

(73) Assignee: JIO PLATFORMS LIMITED, Ahmedabad, Gujarat (IN)

(21) Appl. No.: 18/992,217

(22) PCT Filed: May 20, 2024
(86) PCT No.: PCT/IN2024/050591

§ 371 Date: Jan. 8, 2025

(30) Foreign Application Priority Data
Jun. 29, 2023 (IN) 202321043821

(51) Int. Cl. H04L 41/22; G06F 3/0482; H04W 24/08

(52) U.S. Cl. CPC H04L 41/22; G06F 3/0482; H04W 24/08

(57) ABSTRACT

The disclosed system (100) and method (1200) for data visualization and management in a telecommunication network is disclosed. The system incorporates one or more processors that receive user inputs for identifying network nodes. A unified user interface (UI) (102) is employed to present a spider view menu with multiple segments corresponding to pre-processed data categories, including alarms (104), key performance indicators (KPIs) (106), properties (108), capacity (110), and configuration (112). The data is sourced from a database (103) linked to the processors (105). The UI (102) is designed to offer one-click access to detailed data, eliminating the need for multiple logins. It also features real-time updates and displays information, color-coded for distinction, enabling interactive engagement with the data. The processors are adept at synchronizing the management of diverse network node types, hardware vendors, and server systems, streamlining network operations and oversight.

### RESERVATION OF RIGHTS

A portion of the disclosure of this patent document contains material which is subject to intellectual property rights such as, but are not limited to, copyright, design, trademark, Integrated Circuit (IC) layout design, and/or trade dress protection, belonging to Jio Platforms Limited (JPL) or its affiliates (herein after referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### TECHNICAL FIELD

The present disclosure relates to wireless cellular communications, and specifically to a system and a method to use a spider view menu to provide data visualization for information related to wireless cellular network nodes of a cellular network.

### Definition

As used in the present disclosure, the following terms are generally intended to have the meaning as set forth below, except to the extent that the context in which they are used to indicate otherwise.

The expression ‘spider view menu’ used hereinafter in the specification refers to a type of web site or application design that makes use of web scraping technology to extract data from other websites and display it on the user's homepage or within the application itself. The spider view menu allows users to view relevant and up-to-date information from a variety of sources in one place.

These definitions are in addition to those expressed in the art.

### BACKGROUND

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

Currently, network operators face a challenge when it comes to obtaining a comprehensive overview of their site's performance and related information. There is no single, unified platform that allows them to access all the relevant data and properties related to their site in one place. Instead, the network operators are forced to log in to multiple tools, dashboards, and databases, fetch reports, and perform manual analysis. The present approach is cumbersome, time-consuming, and frustrating, as it requires users to have specific logins for each tool they use. As a result, network operators are often unable to obtain a complete picture of their site and may miss important information or insights that could help them optimize their site's performance and improve its user experience.

U.S. Pat. No. 11,178,559B2 describes a method for determining a status (up or down) of a cellular node. This is done by using a discovery mechanism that identifies whether there is a connection available between the node, an intermediate server, and an operational support system (OSS). The solution provided by U.S. Pat. No. 11,178,559B2 is limited to checking whether the node is in service or not.

There is, therefore, a need in the art to provide an improved mechanism for maintaining the site information at a centralized data source for easy and quick availability.

### OBJECTS OF THE PRESENT DISCLOSURE

It is an object of the present disclosure to provide a system and a method to use a spider view menu to provide data visualization for information related to wireless cellular network nodes of a cellular network.

It is an object of the present disclosure to provide a User Interface (UI) for showing specific information about the node with a single click.

It is an object of the present disclosure to eliminate a user's requirement to navigate multiple Uniform Resource Locators (URLs) and perform multiple logins to access and view relevant metrics information from multiple vendors.

It is an object of the present disclosure to provide an easy identification of Key Performance Indicators (KPIs) performance checks using a KPI comparison.

It is an object of the present disclosure to provide maximum observability of the site using the pre-processed data.

It is an object of the present disclosure to provide a comprehensive 360-degree view encompassing fault status (up/down), performance KPIs, node properties, capacity information, and configuration. The disclosed interface enables complete end-to-end observability for any cellular nodes.

### SUMMARY

The present disclosure discloses a method for visualizing and managing data associated with network nodes in a telecommunication network. The method includes storing, in a database, pre-processed data corresponding to a plurality of categories associated with a plurality of network nodes. The method includes receiving, by one or more processor(s), a user input identifying a network node through a unified user interface (UI) from a user. The method includes fetching, by the one or more processor(s), the pre-processed data associated with an identified node from the database based on the received user input. The method includes processing the fetched pre-processed data, on the unified UI, to generate at least one view menu to be displayed on the unified user interface (UI).

In an embodiment, the at least one generated view menu is a spider view menu comprising a plurality of segments, each segment corresponding to each category of the plurality of categories of the pre-processed data.

In an embodiment, the method further includes a step of generating, on the unified UI, a visual representation of the pre-processed data in each segment of the spider view menu, wherein the visual representation is differentiated by color codes based on a category of pre-processed data and a type of network node.

In an embodiment, the method further includes a step of enabling, through the unified UI, a one-click access to fetch a detailed information associated with the plurality of categories of the pre-processed data to the user avoiding additional logins to multiple applications and updating, by the one or more processor(s), the spider view menu in real-time based on updates to the pre-processed data in the database. The method further includes managing, by one or more processor(s), an interaction of the pre-processed data across multiple types of the plurality of network nodes, hardware vendors, and operating servers in a synchronized manner.

In an embodiment, the step of receiving user input further includes identifying the network node through a search functionality within the unified UI based on at least one of geographical information, a hardware vendor, or an operating server.

In an embodiment, the spider view menu further comprises interactive elements configured to navigate to sub-categories of data within each segment.

In an embodiment, the method further includes aggregating, by the one or more processor(s), historical data associated with the alarms category to display an alarm history for the identified node within an alarms segment of the spider view menu. The method further includes comparing, by one or more processor(s), one or more key performance indicators (KPIs) across different cells of the identified node to provide cell-level comparisons within a KPIs segment.

In an embodiment, the method further includes displaying an inventory information, backhaul data, and antenna details within the properties segment of the spider view menu.

The present disclosure discloses a system for visualizing and managing data associated with network nodes in a telecommunication network. The system includes a database, one or more processors, and a unified user interface (UI). The database is configured to store pre-processed data corresponding to a plurality of categories associated with a plurality of network nodes. The one or more processors are configured to receive a user input identifying a network node through a unified user interface (UI) from a user. The one or more processors are further configured to fetch the pre-processed data associated with an identified network node based on the received user input. The one or more processors are further configured to process the fetched pre-processed data to generate at least one view menu to be displayed on the unified user interface (UI).

In an embodiment, the at least one generated view menu is a spider view menu comprising a plurality of segments, each segment corresponding to each category of the plurality of categories of the pre-processed data.

In an embodiment, the one or more processors are further configured to generate a visual representation of the pre-processed data in each segment of the spider view menu on the unified user interface (UI). The visual representation is differentiated by colour codes based on a category of pre-processed data and a type of network node.

In an embodiment, the one or more processors are further configured to enable a one-click access to fetch detailed information associated with the plurality of categories of the pre-processed data to the user avoiding additional logins to multiple applications. The one or more processors is further configured to update the spider view menu in real-time based on real-time updates to the pre-processed data in the database. The one or more processors is further configured to manage an interaction of the pre-processed data across multiple types of the plurality of network nodes, hardware vendors, and operating servers in a synchronized manner.

In an embodiment, the plurality of segments includes is selected from the group consisting of alarms segment, a key performance indicators (KPIs) segment, a properties segment, a capacity segment, and a configuration segment.

In an embodiment, the one or more processors are further configured to identify the node through a search functionality within the unified UI based on at least one of a geographical information, a hardware vendor, or an operating server.

In an embodiment, the spider view menu further includes a plurality of interactive elements configured to navigate to sub-categories of pre-processed data within each segment.

In an embodiment, the one or more processors are further configured to aggregate historical data associated with the alarms category to display an alarm history for the identified node within the alarms segment of the spider view menu. The one or more processors is further configured to compare one or more key performance indicators (KPIs) across different network cells of the identified node to provide cell level comparisons within the KPIs segment.

In an embodiment, the pre-processed data includes a cell level properties data and a site level properties data.

In an embodiment, the unified UI is further configured to display an inventory information, backhaul data, and antenna details within the properties segment of the spider view menu.

The present disclosure discloses a user equipment (UE) configured to visualize and manage data associated with network nodes in a telecommunication network. The user equipment includes a processor, and a computer readable storage medium storing programming for execution by the processor. The processor is configured to store, in a database, pre-processed data corresponding to a plurality of categories associated with a plurality of network nodes. The processor is configured to receive a user input identifying a network node through a unified user interface (UI) from a user. The processor is configured to fetch the pre-processed data associated with an identified node based on the received user input. The processor is configured to process the fetched pre-processed data to generate at least one view menu to be displayed on the unified user interface (UI).

### BRIEF DESCRIPTION OF THE DRAWINGS

In the figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

The diagrams are for illustration only, which thus is not a limitation of the present disclosure, and wherein:

FIG. 1A illustrates an exemplary network architecture of a system for visualizing and managing data associated with network nodes in a telecommunication network, in accordance with embodiments of the present disclosure.

FIG. 1B illustrates a high-level block diagram of the system for providing data visualization for information related to wireless cellular network nodes of a cellular network, in accordance with an embodiment of the disclosure.

FIG. 2 illustrates an exemplary user interface (UI) data flow to provide the data visualization for the information related to the wireless cellular network nodes of the cellular network, in accordance with an embodiment of the disclosure, in accordance with an embodiment of the disclosure.

FIG. 3 illustrates an exemplary UI spider view in layers for a 4G macro site, in accordance with an embodiment of the disclosure.

FIG. 4 illustrates an exemplary alarms view, in accordance with an embodiment of the disclosure.

FIG. 5 illustrates an exemplary key performance indicators (KPI) comparison view, in accordance with an embodiment of the disclosure.

FIG. 6 illustrates an exemplary KPI cell level view, in accordance with an embodiment of the disclosure.

FIG. 7 illustrates an exemplary one or more properties views of site properties, in accordance with an embodiment of the disclosure.

FIG. 8 illustrates an exemplary one or more properties views of cell properties, in accordance with an embodiment of the disclosure.

FIG. 9 illustrates an exemplary capacity view, in accordance with an embodiment of the disclosure.

FIG. 10 illustrates an exemplary configuration view, in accordance with an embodiment of the disclosure.

FIG. 11 illustrates an exemplary computer system in which or with which embodiments of the present disclosure may be implemented.

FIG. 12 illustrates an exemplary flow chart showing a method for visualizing and managing data associated with network nodes in a telecommunication network, in accordance with an embodiment of the disclosure.

The foregoing shall be more apparent from the following more detailed description of the disclosure.

### LIST OF REFERENCE NUMERALS

100—System
101—Network
102—Unified User Interface
103—Database
105—One or More Processors
107—1, 107—2 . . . 107—N—Users
109—1, 109—2 . . . 109—N—Computing Devices
1110—External Storage Device
1120—Bus
1130—Main Memory
1140—Read Only Memory
1150—Mass Storage Device
1160—Communication Port
1170—Processor

### BRIEF DESCRIPTION OF THE INVENTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address any of the problems discussed above or might address only some of the problems discussed above. Some of the problems discussed above might not be fully addressed by any of the features described herein. Example embodiments of the present disclosure are described below, as illustrated in various drawings in which like reference numerals refer to the same parts throughout the different drawings.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process that is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive like the term “comprising” as an open transition word without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is to describe particular embodiments only and is not intended to be limiting the disclosure. As used herein, the singular forms “a”, “an”, and “the” are intended to include the plural forms as well, unless the context indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any combinations of one or more of the associated listed items. It should be noted that the terms “mobile device”, “user equipment”, “user device”, “communication device”, “device” and similar terms are used interchangeably for the purpose of describing the invention. These terms are not intended to limit the scope of the invention or imply any specific functionality or limitations on the described embodiments. The use of these terms is solely for convenience and clarity of description. The invention is not limited to any particular type of device or equipment, and it should be understood that other equivalent terms or variations thereof may be used interchangeably without departing from the scope of the invention as defined herein.

As used herein, an “electronic device”, or “portable electronic device”, or “user device” or “communication device” or “user equipment” or “device” refers to any electrical, electronic, electromechanical, and computing device. The user device is capable of receiving and/or transmitting one or parameters, performing function/s, communicating with other user devices, and transmitting data to the other user devices. The user equipment may have a processor, a display, a memory, a battery, and an input-means such as a hard keypad and/or a soft keypad. The user equipment may be capable of operating on any radio access technology including but not limited to IP-enabled communication, Zig Bee, Bluetooth, Bluetooth Low Energy, Near Field Communication, Z-Wave, Wi-Fi, Wi-Fi direct, etc. For instance, the user equipment may include, but not limited to, a mobile phone, smartphone, virtual reality (VR) devices, augmented reality (AR) devices, laptop, a general-purpose computer, desktop, personal digital assistant, tablet computer, mainframe computer, or any other device as may be obvious to a person skilled in the art for implementation of the features of the present disclosure.

Further, the user device may also comprise a “processor” or “processing unit” includes processing unit, wherein processor refers to any logic circuitry for processing instructions. The processor may be a general-purpose processor, a special purpose processor, a conventional processor, a digital signal processor, a plurality of microprocessors, one or more microprocessors in association with a DSP core, a controller, a microcontroller, Application Specific Integrated Circuits, Field Programmable Gate Array circuits, any other type of integrated circuits, etc. The processor may perform signal coding data processing, input/output processing, and/or any other functionality that enables the working of the system according to the present disclosure. More specifically, the processor is a hardware processor.

As portable electronic devices and wireless technologies continue to improve and grow in popularity, the advancing wireless technologies for data transfer are also expected to evolve and replace the older generations of technologies. In the field of wireless data communications, the dynamic advancement of various generations of cellular technology are also seen. The development, in this respect, has been incremental in the order of second generation (2G), third generation (3G), fourth generation (4G), and now fifth generation (5G), and more such generations are expected to continue in the forthcoming time.

While considerable emphasis has been placed herein on the components and component parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

Currently available solutions to obtain and visualize site information requires a user to log into multiple tools, dashboards, and databases for fetching data. The user is then required to perform manual analysis on the fetched data to extract relevant information. Further, the available solutions do not have a single touchpoint to help visualize all of the relevant information and properties related to the site. Extracting and analyzing the data manually is tiresome and time-consuming and requires specific logins at a data extraction interface. A single, integrated platform that brings together all the relevant data and tools would be a significant improvement, allowing users to monitor and analyze their site's performance, identify areas for improvement, and make data-driven decisions to optimize their site's success more easily.

The present disclosure provides a system and a method for visualizing key metrics of wireless nodes of a wireless network using a spider view menu and enables reviewing all site-specific details in one interface with a simple click. The disclosed system and method use a combination of multiple data sources, such as alarms and site status from a fault management data source, Key Performance Indicators (KPI's) and capacity from a performance management data source, site details from multiple vendors databases, configuration details from a BTS management data source, thus covering all details specific to the site. By clicking on the site/sector, a user may navigate into all these details from a spider view menu. Further, in a User Interface (UI), these details are aggregated into respective menus such as an alarm's menu, KPI's menu, properties menu, capacity menu, and a configuration menu. As a bird eye view of the site is available, the user may extract information from the same location quickly and check into any data.

Availability of a centralized data source for easy and readable availability of all information of the site from a same location facilitates to reduce an effort to login into multiple applications. For example, if an engineer needs to check any alarms, or history of alarms and KPI performance of a particular site, he/she needs to log into an alarm management module/application/BTS manager module to find out active alarms present in that site, or into a performance manager/mycom/other applications to download the KPIs. However, the disclosed system and method enables the user to only log into a cognitive platform and click on a specific site to obtain the relevant required information. Using a spider-view menu, the user is configured to obtain information about both the KPIs and alarms without having a need to switch between multiple applications.

The disclosed system and method access all critical data sources of a wireless cellular node of all site types such as that of a macro cell, a small cell, nodes with hardware of different vendors, nodes that are connected to different operating server systems, with one click on the specific site. With this solution, the user may only need to search for a ‘node id’ in cognitive platform layers and click on that site. All details related to that node are thus made available in a spider view thereby avoiding the user's need to log into any other application. For example, if an engineer wants to look after a specific area containing sites with hardware of ‘A’ and another with that of ‘B’, to get the configuration details of the ‘A’ site he is required to log into ‘A's’ application, and for another site he need to log into ‘B's’ application. However, the need to log into different applications is resolved using the disclosed system and method as the information is provided as the spider view menu data readily available at “configuration” tab.

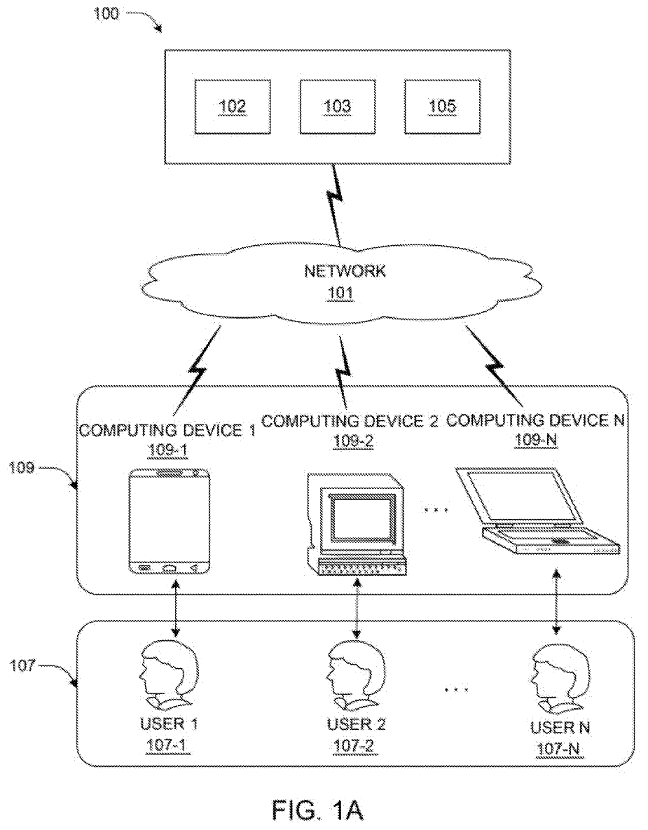

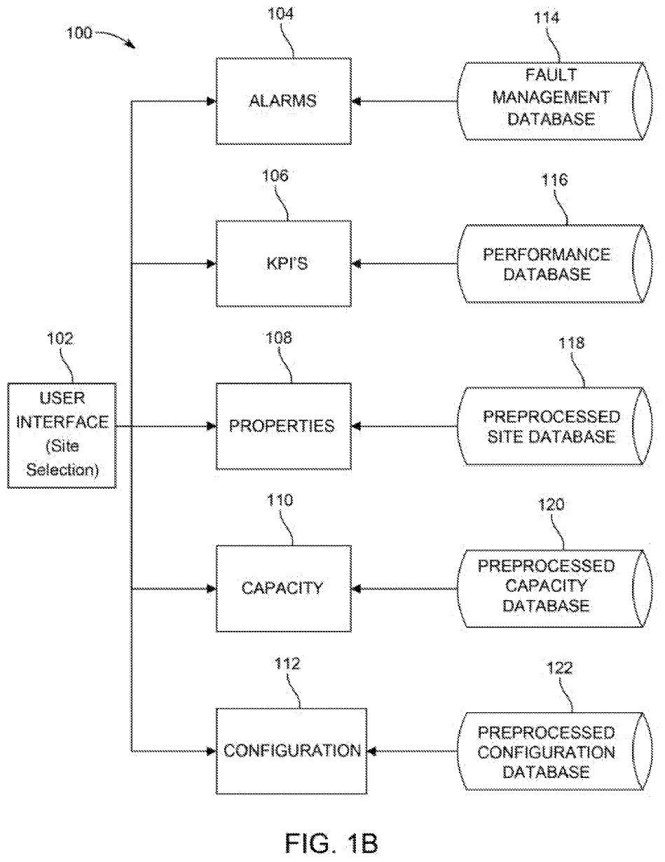

The various embodiments throughout the disclosure will be explained in more detail with reference to FIG. 1A-FIG. 12.

FIG. 1A illustrates an exemplary network architecture of a system (100) for visualizing and managing data associated with network nodes in a telecommunication network, in accordance with embodiments of the present disclosure.

As illustrated in FIG. 1A, one or more user equipment (UE) (109-1, 109-2 . . . 109-N) are connected to the system (100) through a network (101). A person of ordinary skill in the art will understand that the one or more user equipments (109-1, 109-2 . . . 109-N) may be collectively referred to as user equipments (UEs) (109) and individually referred as user equipment (UE) (109). A person of ordinary skill in the art will understand that the one or more users (107-1, 107-2 . . . 107-N) may be collectively referred to as users (107) and individually referred to as user (107).

In an embodiment, the UE (109) may include, but not be limited to, a mobile, a laptop, etc. Further, the UE (109) may include one or more in-built or externally coupled accessories including, but not limited to, a visual aid device such as a camera, audio aid, microphone, or keyboard. Further, the UE (109) may include a mobile phone, smartphone, virtual reality (VR) devices, augmented reality (AR) devices, a laptop, a general-purpose computer, a desktop, a personal digital assistant, a tablet computer, and a mainframe computer. Additionally, input devices for receiving input from a user such as a touchpad, touch-enabled screen, electronic pen, and the like, may be used. In an embodiment, users/customers may submit their user inputs (requests) through the UE, as shown in FIG. 1A.

In an embodiment, the network (101) may include, by way of example but not limitation, at least a portion of one or more networks having one or more nodes that transmit, receive, forward, generate, buffer, store, route, switch, process, or a combination thereof, etc. one or more messages, packets, signals, waves, voltage or current levels, some combination thereof, or so forth. The network (101) may also include, by way of example but not limitation, one or more of a wireless network, a wired network, an internet, an intranet, a public network, a private network, a packet-switched network, a circuit-switched network, an ad hoc network, an infrastructure network, a Public-Switched Telephone Network (PSTN), a cable network, a cellular network, a satellite network, a fiber optic network, or some combination thereof.

The system (100) includes a database (103), one or more processors (105), and a unified user interface (UI) (102).

The database (103) is configured to store pre-processed data corresponding to a plurality of categories associated with a plurality of network nodes. In an example, the pre-processed data includes a cell level properties data, and a site level properties data. In an example, the plurality of categories includes information selected from the group consisting of alarms category, a key performance indicators (KPIs) category, a properties category, a capacity category, and a configuration category. In an example, the database (103) is configured to store pre-processed data corresponding a plurality of segments. In an example, each segment represents a category of the plurality of categories of the pre-processed data. The database (103) is configured to store program instructions. The database (103) is configured to store a user input received from the user (end user). The program instructions include a program that implements a method to visualize and manage data associated with network nodes in a telecommunication network in accordance with embodiments of the present disclosure and may implement other embodiments described in this specification. The database (103) may include any computer-readable medium known in the art including, for example, volatile memory, such as Static Random Access Memory (SRAM) and Dynamic Random Access Memory (DRAM) and/or non-volatile memory, such as Read Only Memory (ROM), erasable programmable ROM, flash memories, hard disks, optical disks, and magnetic tapes.

The one or more processors (105) is configured to receive a user input identifying a network node through the unified user interface (UI) (102) from the user. In an example, the user input includes a network node identity code. The one or more processors is further configured to fetch the pre-processed data associated with an identified network node based on the received user input. The one or more processors (105) is further configured to process the fetched pre-processed data at to generate at least one view menu to be displayed on the unified user interface (UI) (102). For example, the at least one generated view menu is a spider view menu. In examples, the spider view menu is a type of visualization where data or information is organized in a spider chart or radar chart. The spider view menu displays multivariate data in the form of a two-dimensional chart with three or more quantitative variables represented on axes starting from the same point. In an example, the spider view menu employs data scraping process to collect data from various information sources. The data scraping process involves automatically extracting information from different data sources and displaying the extracted information on the unified user interface (UI) (102). The spider view menu offers the users a convenient way to view relevant and current information from different data sources in one place. By utilizing “spider view menu”, users can stay updated with the latest updates, trends, and information in an effortless manner. The spider view menu is useful for regularly tracking multiple sources of information.

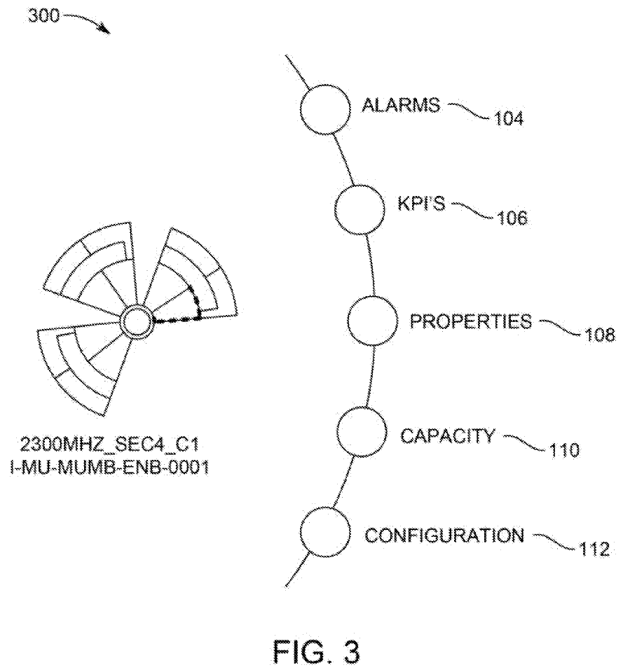

In an aspect, the spider view menu is designed by identifying variables (referred to as segments in the disclosure) that are to be visualized. In an aspect, the spider view menu includes a plurality of segments. In an example, the spider view menu further includes a plurality of interactive elements configured to navigate to sub-categories of pre-processed data within each segment. Each segment represents a category of the plurality of categories of the pre-processed data. In an example, the plurality of segments is selected from the group consisting of alarms segment, a key performance indicators (KPIs) segment, a properties segment, a capacity segment, and a configuration segment. For example, the alarms segment represents the alarms category of the pre-processed data. Next, for each segment, the pre-processed data sources are identified and linked with the corresponding segment. In examples, the pre-processed data sources may correspond to a database or plurality of databases. When the spider view is implemented, data is scraped from the data sources. In some aspects, the segments may be scaled. In an example, the segments may be scaled on a categorical scale such as low, medium, or high. In another example, the segments may be scaled on a numerical scale. Other examples of scaling not disclosed here are contemplated herein. In an optional aspect, the data may be normalized at a pre-processing stage to provide the data at a common scale for comparison. Further, visualization tools including but not limited to Tableau, Python libraries such as Matplotlib, or Plotly, Power BI, and R may be used to create the spider view menu. In the next step, each of the segments is plotted on a separate axis emanating from the centre of the chart. In aspects, the number of axes may be equal to the number of segments. The segments may be arranged evenly around the center. The one or more processors (105) is further configured to provide a visual representation (each segment of the spider view menu) of the pre-processed data to the unified user interface (UI) (102) (refer FIG. 3). In an example, the visual representation may be differentiated by different colour codes based on a category or segment of the pre-processed data and a type of the network node.

In an embodiment, the one or more processors (105) are further configured to enable a one-click access (“click once to gain access”) to detailed information for the plurality of categories of the pre-processed data to the user, avoiding additional logins to multiple applications. In an aspect, one-click access of the present invention involves building a “smart-link,” which is configured to replace the native or manual end-user actions that would be required to get access to web resources. The native or manual end-user actions may span numerous online platforms requiring multiple links to be followed, redirects, interstitial pages, completion and submission of forms, user authentications, and the like. In an aspect, the present system may be configured to perform these actions in the background, hidden from the user, and presented as the one-click access (e.g., one-click button shown on the unified UI (102)). One or more processors (105) are further configured to update the spider view menu in real-time based on real-time updates to the pre-processed data in the database (103). The one or more processors (105) is further configured to manage an interaction of the pre-processed data across multiple types of the plurality of network nodes, hardware vendors, and operating servers in a synchronized manner.

In an embodiment, the one or more processors (105) are further configured to identify the network node through a search functionality within the unified UI (102) based on at least one of a geographical information, a hardware vendor, or an operating server.

In an embodiment, the one or more processors (105) are further configured to aggregate historical data associated with the alarms category (alarms segment) to display an alarm history for the identified node within the alarms segment of the spider view menu (130, 132). The one or more processors (105) is further configured to compare one or more KPIs across different network cells of the identified node to provide cell level comparisons within the KPIs segment (136, 138).

In an embodiment, the unified UI (102) is further configured to display an inventory information, backhaul data, and antenna details within the properties segment of the spider view menu.

FIG. 1B illustrates a high-level block diagram of the system (100) providing data visualization for information related to wireless cellular network nodes of a cellular network, in accordance with an embodiment of the disclosure. As is illustrated, the data visualization facilitates bringing all the node related details at a single source so that the information details may be accessed/read from the same location. By clicking on the site in the spider view, the user may obtain the information such as the “alarms”, “KPIs”, “properties”, “capacity” and “configuration”. The alarms may contain both active alarms present in the site, alarm history or site status. The KPI may carry cell level KPI or cell level KPI comparison for easy processing. The properties may contain cell-level and site-level information like geographical information, antenna info, inventory, backhaul, etc. The capacity may provide the KPI insight into capacity planning. The antenna and general configuration of the site are made available from the configuration tab. As may be appreciated, pre-processed databases may be connected to the cognitive platform UI to provide adequate data for visualization of the cognitive platform's layers.

FIG. 1A-1B illustrate the exemplary architectures of the system (100) for a unified data visualization and management system implemented in a telecommunications network environment, in accordance with embodiments of the present disclosure. As is illustrated, the data visualization facilitates bringing all the node related details at a single source so that the information details may be accessed/read from the same location.

Referring to FIG. 1A, the system architecture (100) includes a Site Selection component (unified UI) (102) that interfaces with the user. A person of ordinary skill in the art will understand that Site Selection UI (102) serves as the initiation point for user interaction, allowing for the selection and identification of a node within the telecommunications network.

In an embodiment, the alarms component (alarms segment) (104) interfaces with a fault management database (114) to provide real-time and historical alarm data. The alarms component (104) can present this information through the unified user interface, negating the need for separate alarm management tools. The alarms segment (104) may include, but is not limited to, visual alarm indicators, categorized alarm lists, and interactive alarm histories. The alarms may contain both active alarms present on the site, alarm history, or site status.

In an embodiment, the KPIs component (KPIs segment) (106) may carry cell level KPI or cell level comparison for easy processing. The KPI may retrieve performance metrics from a performance database (116). These metrics may include data throughput, signal quality, and other relevant performance indicators. The KPIs component (106) enables users to compare performance across different cells or sites within the network.

Referring to FIG. 1B, the properties component (properties segment) (108) accesses a preprocessed site database (118) to provide detailed site-level property data and cell-level property data. The properties segment facilitates the display of comprehensive information, including, but not limited to, hardware configurations, geographic location, and backhaul arrangements.

In another exemplary embodiment, the capacity component (capacity segment) (110) draws from a preprocessed capacity database (120) to offer insights into network usage and capacity planning. This component may include visualizations such as utilization graphs, capacity forecasts, and load distribution maps.

The configuration component (configuration segment) (112) interacts with a preprocessed configuration database (122) to allow for the management of network node settings. In an embodiment, the configuration component (112) includes a configuration panel through which users can modify and manage various network parameters.

The unified user interface (102) is configured to display the spider view menu that organizes the data into visually distinct segments for alarms (104), KPIs (106), properties (108), capacity (110), and configuration (112). Each segment includes interactive elements, allowing for detailed exploration within each data category.

The processors within the system are configured to enable one-click access to this detailed information through the unified user interface. This one-click functionality provides streamlined access to a range of data without requiring additional logins or application navigation. With the one-click functionality, the system is configured to streamline a workflow by eliminating the need for additional logins or application navigations. The one-click functionality is configured to allow saving time and effort by providing quick and easy access to the information that the user needs.

In an implementation, the system (100) allows for real-time updates to the displayed data as changes occur within the underlying databases. This ensures that users have access to the most current information.

In an implementation, the system is designed to manage and synchronize the display and interaction with pre-processed data across various types of wireless cellular network nodes, hardware vendors, and operating server systems, ensuring consistency and coherence in the data visualization.

In accordance with embodiments of the present disclosure, the system (100) may be designed and configured for simplifying the management and visualization of telecommunications network data, centralizing access to various data types, and enhancing network monitoring and management efficiency.

The present disclosure provides a 360-degree aspect covering fault (up/down), performance KPI, node properties, capacity details, and configuration. The present disclosure interface allows a user to get complete end-to-end observability for any cellular node.

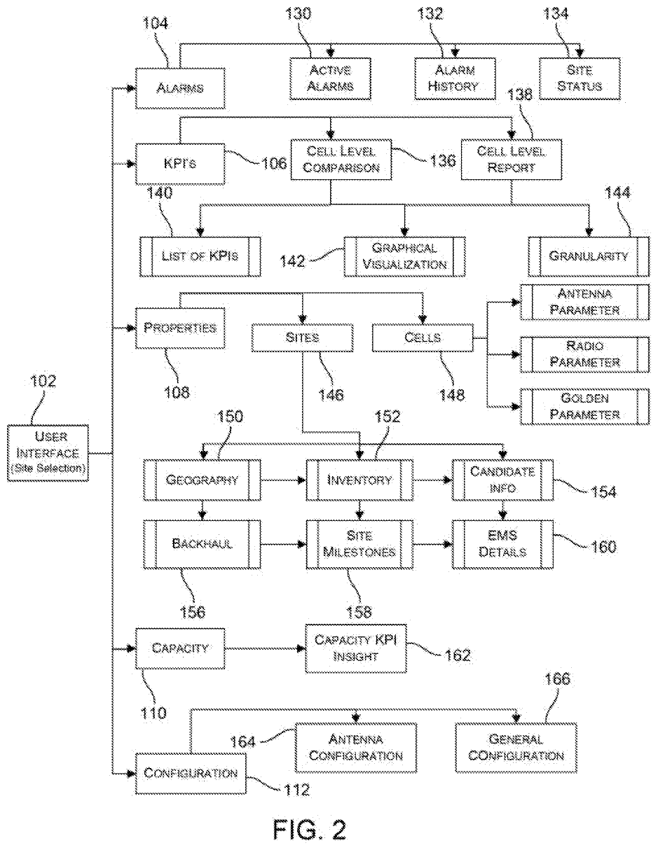

FIG. 2 illustrates a high-level block diagram of the system (100) for providing data visualization for information related to wireless cellular network nodes in a telecommunications network, in accordance with an embodiment of the disclosure. The system (100) is configured to consolidate node-related details into a single source, enabling users to access and read information from the same location, thereby streamlining the data management process.

The site selection (unified user interface) (102) serves as a gateway for users to access the system (100). The unified user interface (102) allows users to input or query node identifications using criteria such as network identifiers or geographical locations. For example, the user can input a site code or select a node from a map representation within the unified user interface.

The alarms component (104) is configured for network health monitoring. The alarms component (104) consists of three main subcomponents: active alarms (130), alarm history (132), and site status (134). The active alarms (130) provide real-time alerting for immediate issues that need attention, such as system outages or performance degradations. The alarm history (132) maintains a record of resolved and acknowledged alarms, enabling trend analysis and proactive maintenance scheduling. The site status (134) offers a snapshot of the current operational condition of the network node, which can indicate statuses such as ‘operational,” ‘under maintenance,’ or ‘out of service.’

The KPI's component (106) facilitates performance tracking and benchmarking. The cell level comparison (136) allows for side-by-side analysis of performance between different network cells, aiding in identifying underperforming sectors. The cell level report (138) generates detailed reports on individual cell performance, which might include metrics such as signal-to-noise ratios or user throughput. The list of KPIs (140) can be a dynamic checklist that network operators use to monitor the performance indicators. The graphical visualization (142) transforms complex data sets into easy-to-understand charts or heat maps, providing at-a-glance insights into network performance. The granularity (144) enables users to drill down into specific data points for a more detailed investigation, such as examining hourly traffic patterns or service uptake rates.

The properties component (108) details the physical and logistical aspects of network nodes. The properties component (108) includes sites (146) which can contain data on site infrastructure and cells (148) with information on individual cell characteristics (antenna parameter, radio parameter, golden parameter). The geography (150) might involve mapping functionality to show the location and coverage area of network nodes. The inventory (152) details the hardware and equipment at each site, such as the number of transceivers or the types of antennas used. The candidate info (154) can provide a selection of potential sites for network expansion, including feasibility data. The backhaul (156) relates to the connectivity between the cell site and the core network, potentially including fiber optic and microwave links. The site milestones (158) can track the historical upgrades and maintenance activities. The EMS details (160) would give insights into the network (element) management systems used for each site.

The capacity component (110) includes capacity KPI Insight (162), which is essential for planning network expansion and avoiding congestion. This component may use predictive analytics to forecast future network load and recommend capacity upgrades.

The configuration component (112) consists of antenna configuration (164) and general configuration (166). The antenna configuration (164) would allow technicians to adjust settings such as tilt, azimuth, and power levels to optimize coverage and capacity. The general configuration (166) might cover broader network settings, including software versions, feature activations, and protocol settings.

The system (100) integrates these components within the unified user interface that streamlines the network management process. The one-click access feature minimizes the need for navigating through multiple systems or logging into different management platforms. This unified approach is designed to provide a more efficient and user-friendly experience for network operators, reducing the time and complexity associated with traditional network management tasks.

FIG. 3 illustrates an exemplary UI spider view in layers for a 4G macro site, in accordance with an embodiment of the disclosure. The spider view menu (also referred as “spider view”) is a feature that automatically extracts information from various sources and displays the extracted information on the user interface (UI) that is easy to navigate. In examples, the spider view menu is a type of visualization where data or information is organized in a spider chart or radar chart. The spider view menu displays multivariate data in the form of a two-dimensional chart with three or more quantitative variables represented on axes starting from the same point. The data points are plotted on the axes and connected to form a polygon, resembling a spider's web. The spider view menu is designed to provide users with a convenient way to view relevant and up-to-date information from different sources at one place, thereby saving time and effort by avoiding the need to visit multiple websites or applications to gather information. The spider view menu enables users to stay informed and up-to-date with minimal effort. By providing a centralized location for accessing information from multiple sources, it makes it easier for users to stay familiar with updates and trends.

Referring to FIG. 3, a visual representation 300 of a data management and visualization interface (102) is displayed, which is employed in a telecommunications network to facilitate the monitoring and administration of wireless cellular network nodes.

The interface is the node identifier, which provides the essential details of the network node in question, such as its frequency band “2300 MHz”, sector “Sec4_C1”, and a unique identifying code “I-MU-MUMB-ENB-0001”. This identifier serves as the focal point from which all data categories are accessed.

Radiating from the node identifier is the alarms segment (104). This segment is tailored to present a comprehensive overview of the current and historical alarm data for the node. It is designed to alert network operators to any immediate or past issues that need attention, offering a streamlined approach to fault management.

Further to the alarms segment is the Key Performance Indicators (KPIs) segment (106). The interface (102) is configured to display various performance metrics that are vital to assessing the health and efficiency of the network node.

The properties segment (108) provides detailed information on the node's characteristics. The properties segment (108) encompasses a broad range of data, including the node's physical attributes, operational settings, and other pertinent properties that define its functionality within the network.

The capacity segment (110) is configured to monitor the network node's usage statistics and future capacity requirements. The capacity segment (110) provides insights into the network's current load and assists in forecasting future demands to ensure optimal performance.

The configuration segment (112) segment offers an interface through which the network's technical settings can be viewed and adjusted. The settings are important for maintaining the node's performance and for implementing changes to its operational parameters.

Each segment within the interface is designed for ease of use, with visual and interactive elements that allow network operators to quickly navigate and interpret the data presented. The interface aims to consolidate complex data into a single, accessible point, thus simplifying the task of network management and enhancing operational efficiency within the telecommunications network.

The unified UI (102) is configured to generates the visual representation of the pre-processed data in each segment of the spider view menu.

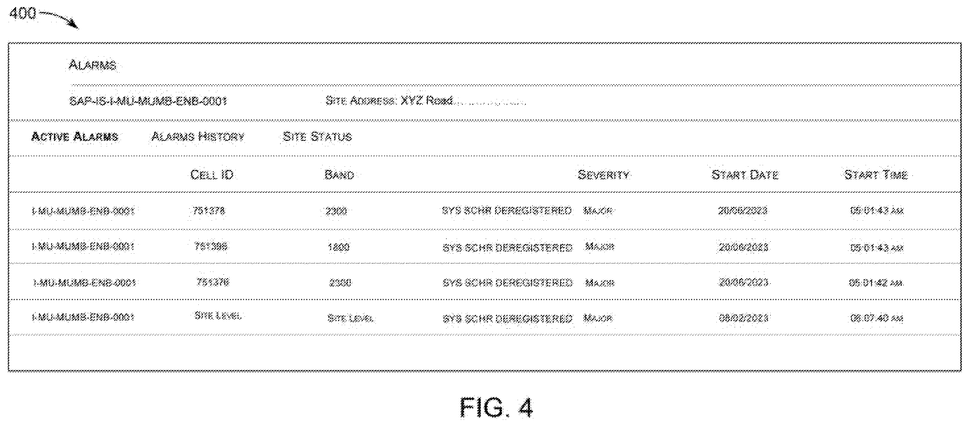

FIG. 4 illustrates an exemplary alarms view, in accordance with an embodiment of the disclosure. FIG. 4 illustrates an alarm management interface (400), which is part of a telecommunications system for monitoring and managing network alarms. The interface (400) provides a detailed view of active alarms for a network node identified as “SAP-IS-I-MU-MUMB-ENB-0001”.

The header of the interface indicates the SAP ID of the network node and provides a specific site address, “XYZ road,” accompanied by a numerical code, suggesting the physical location of the network equipment.

The interface is segmented into columns displaying various details about the alarms. The “Cell ID” column lists unique identifiers for different cells within the network node, such as “751378,” “751396,” and “751376,” which may correspond to specific transceivers or sectors of the node.

The “Band” column specifies the frequency band of the alarm, with entries such as “2300” and “1800,” likely referring to the radio frequency in megahertz used by the respective cells.

The “Severity” column categorizes the urgency of the alarms, with each alarm in this figure marked as “MAJOR,” indicating significant issues that can affect network performance or availability.

The “Start Date” and “Start Time” columns provide timestamps for when each alarm was triggered. For example, several alarms were logged on “20/06/2023” with times “05:01:43 AM,” indicating the precise moments when the network node reported these issues.

One entry is distinguished as “Site Level,” suggesting an alarm that impacts the entire site rather than a specific cell. The alarm also has a different start date, “Aug. 2, 2023,” and time “06:07:40 AM,” which might indicate an earlier or more persistent issue.

Each row under the “ACTIVE ALARMS” section of the interface corresponds to a specific alarm event, systematically catalogued for network administrators to address. The interface layout allows for quick identification of problem areas within the network node, facilitating timely responses to maintain service quality and network integrity.

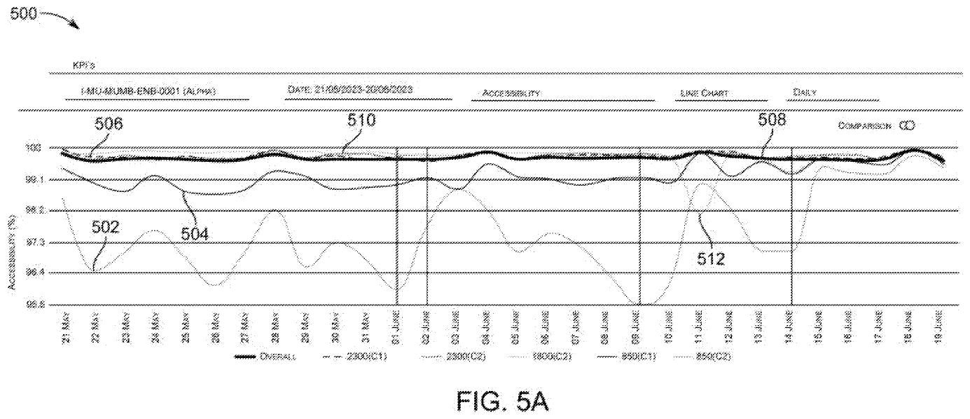

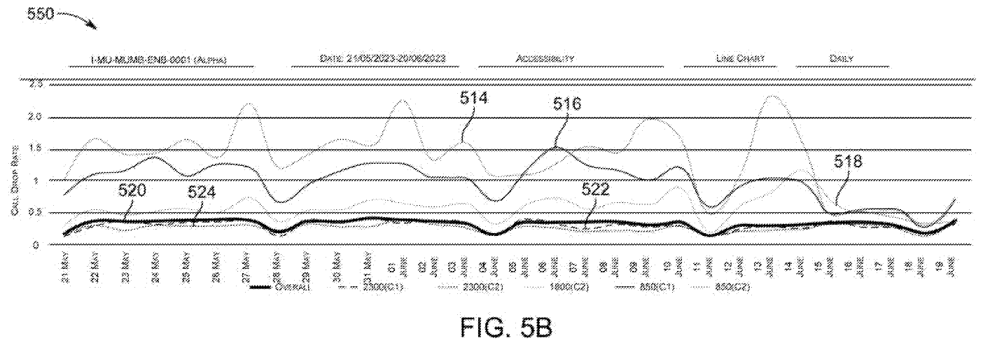

FIG. 5 illustrates an exemplary KPI comparison view 500, in accordance with an embodiment of the disclosure. Figure is a graphical representation of Key Performance Indicators (KPIs) for a wireless cellular network node, as displayed on a data visualization system. The figure shows two separate graphs, each tracking different KPIs over a specified date range from specific dates, for example, May 21, 2023, to Jun. 20, 2023.

In the upper graph, the KPI of Accessibility is plotted, which is indicated by curve 502. This KPI shows the percentage of successful connections to the network node over time. The curve 504 represents the overall accessibility for the node, while the curve 506 and curve 508 lines represent accessibility for specific frequency bands, labelled as 2300 (C1) and 2300 (C2), respectively. A third frequency band, 1800 (C2), is shown by a dash-dotted line 510, and the fourth frequency band, 850 (C1), is denoted by a short-dash line 512. These lines illustrate the accessibility performance of each carrier frequency and the combined performance of all carriers over the observed period.

The lower graph presents the KPI of Call Drop Rate, shown by curve 514. This KPI measures the frequency at which calls are dropped or disconnected unexpectedly within the network node's service area. The overall Call Drop Rate for the node is depicted by the curve 516, while the individual performance of each frequency band is represented by lines similar to those in the Accessibility graph for 2300 (C1) shown by curve 518, for 2300 (C2) indicated by curve 520, for 1800 (C2) displayed by curve 522, and for 850 (C1) represented by curve 524.

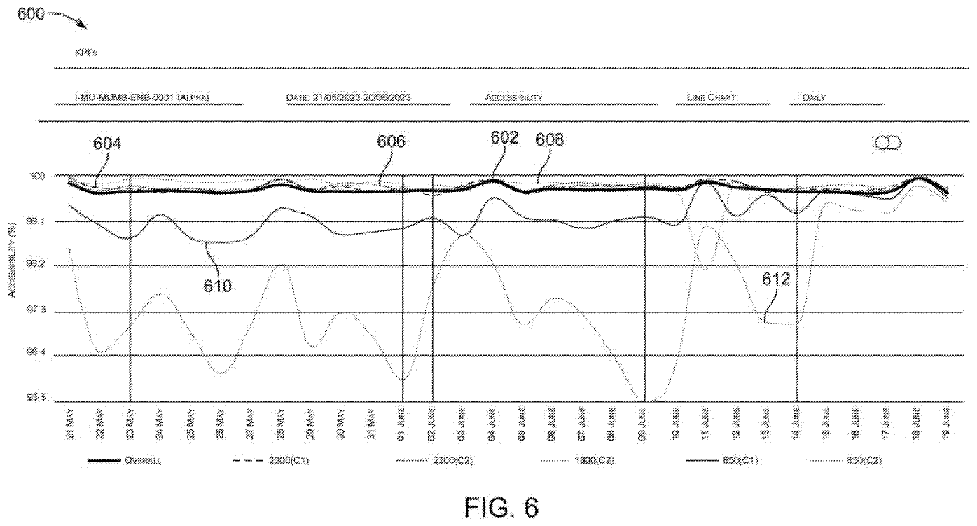

FIG. 6 illustrates an exemplary KPI cell level view 600, in accordance with an embodiment of the disclosure. FIG. 6 presents a line graph that illustrates the Accessibility Key Performance Indicator (KPI) for a specific wireless cellular network node identified as “I-MU-MUMB-ENB-0001.” The data span from specific dates, for example, May 21, 2023, to Jun. 20, 2023, and show daily performance across various frequency bands.

The solid line (602) represents the Overall Accessibility of the node, aggregating the accessibility across all frequency bands. This line indicates the percentage of successful service access attempts within the network node's coverage area.

The curve (604) corresponds to the accessibility performance on the frequency band labelled 2300 (C1). The curve (604) shows the fluctuations in accessibility within this specific carrier frequency, illustrating its individual performance apart from the aggregate.

Similarly, the curve (606) represents the accessibility KPI for the frequency band 2300 (C2). The curve (606) allows for the monitoring of this particular carrier frequency's performance over the specified period.

The curve (608) tracks the accessibility for the frequency band 1800 (C2), providing insights into the service access success rates for users connected via this frequency.

The curve (610) and the curve (612) represent the accessibility KPIs for the frequency bands 850 (C1) and 850 (C2), respectively. These curves provide a visual depiction of accessibility performance for these lower frequency bands, often associated with broader coverage but potentially different user densities and usage patterns.

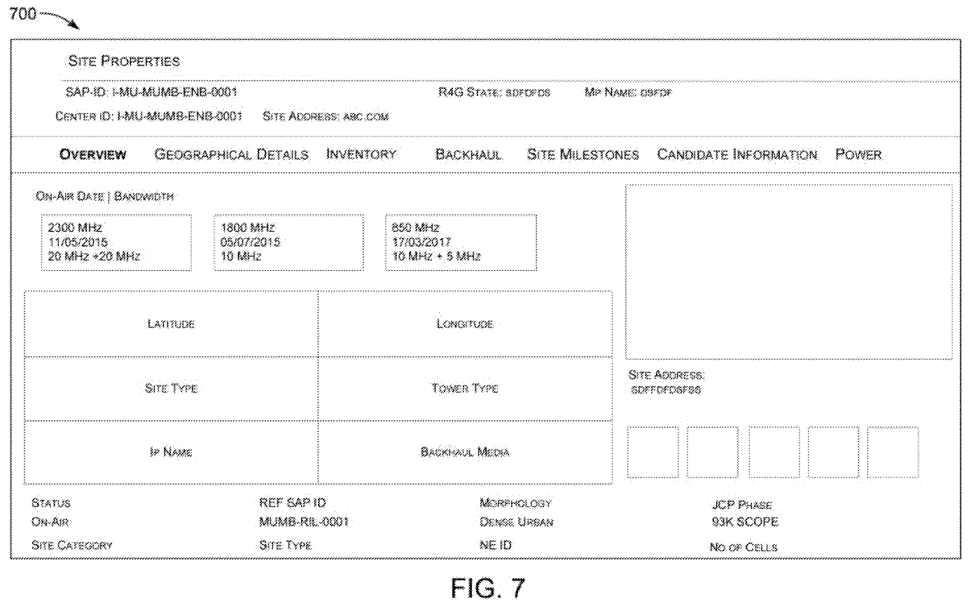

FIG. 7 illustrates exemplary properties view 700 of site properties, in accordance with an embodiment of the disclosure. The figure displays a screen 700 through a user interface for the site properties of a wireless cellular network node. The user interface is part of a comprehensive data management system designed to provide detailed information on network nodes within a telecommunications network.

The header of the user interface shows the identifier “SAP-ID: I-MU-MUMB-ENB-0001” along with the “CENTER ID,” which is identical, indicating that this information pertains to a specific node within the network. The header also includes a “SITE ADDRESS” field, populated with “abc.com,” which can represent either the physical or network address of the node.

Tabs at the top of the interface indicate different categories of information that can be accessed: “OVERVIEW,” “GEOGRAPHICAL DETAILS,” “INVENTORY,” “BACKHAUL,” “SITE MILESTONES,” “CANDIDATE INFORMATION,” and “POWER.” Each tab would present a different aspect of the site's data when selected.

Within the “OVERVIEW” section, there are fields for “On-Air Date” and “Bandwidth” corresponding to different frequency bands utilized by the node. For example, the frequency band “2300 MHz” has an on-air date of “Nov. 5, 2015” with bandwidth details “20 MHz+20 MHz.” This suggests that the site has been operational from the specified date and indicates the total bandwidth allocated to that frequency.

Other frequency bands, such as “1800 MHZ” and “850 MHZ,” are also listed with their respective on-air dates and bandwidth configurations. This provides a quick reference to the operational timelines and capacity of each frequency band at the node.

The interface includes placeholders for geographic coordinates, with fields for “LATITUDE” and “LONGITUDE,” ensuring that precise location data for the site is accessible. Additional details such as “SITE TYPE,” “TOWER TYPE,” “BACKHAUL MEDIA,” “STATUS,” “REF SAP ID,” “MORPHOLOGY,” “NE ID,” “JCP PHASE,” “93K SCOPE,” and “NO OF CELLS” are provided to offer a comprehensive overview of the site's characteristics and operational status.

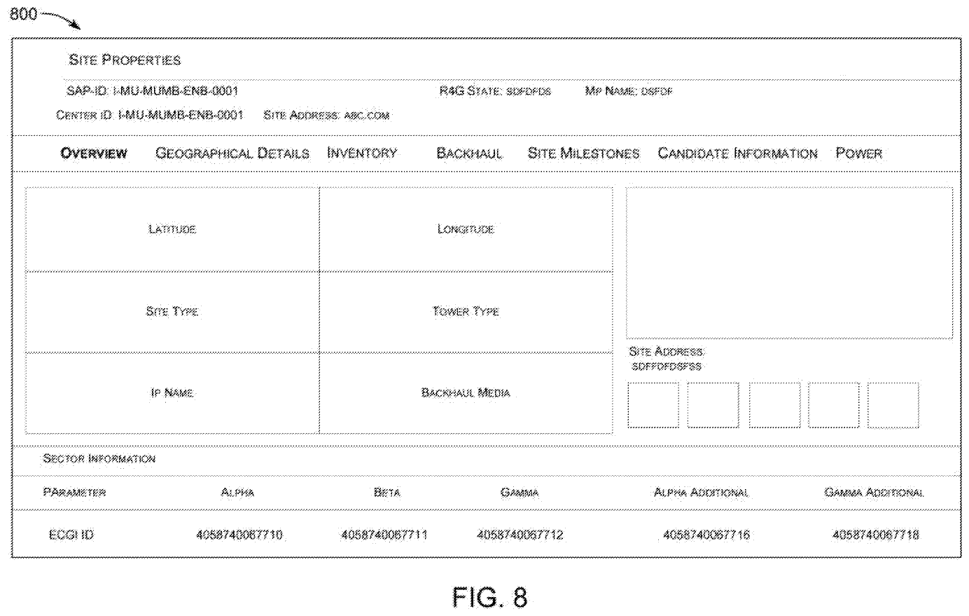

FIG. 8 illustrates exemplary properties view 800 of cell properties, in accordance with an embodiment of the disclosure. The figure, denoted as 800, exhibits a structured user interface layout of site properties for a telecommunications network node. The interface is part of an advanced system used to compile and display detailed information for network management.

The top section of the interface features identifying information for the network node, including “SAP-ID: I-MU-MUMB-ENB-0001” and “Center ID: I-MU-MUMB-ENB-0001,” which designate the specific node being referenced. Additional details such as “R4G State: SDFDFS” and “MP Name: DSFDF” are provided, likely indicating the operational state and maintenance provider for the node. The “SITE ADDRESS” is also listed, offering a network or physical location address for the node, shown here as “abc.com.”

A tabbed structure organizes the data into categories such as “OVERVIEW,” “GEOGRAPHICAL DETAILS,” “INVENTORY,” “BACKHAUL,” “SITE MILESTONES,” “CANDIDATE INFORMATION,” and “POWER.” Selecting these tabs would display corresponding data in the interface.

In the “OVERVIEW” section, placeholders are present for critical site information including “LATITUDE,” “LONGITUDE,” “SITE TYPE,” “TOWER TYPE,” and “IP NAME.” This section is intended to provide a snapshot of the most significant and commonly referenced data regarding the network node.

The “BACKHAUL MEDIA” field suggests a focus on the connectivity aspects of the node, detailing the types of backhaul connections employed, such as fiber, microwave, or satellite.

Additionally, the lower portion of the interface under the header “SECTOR INFORMATION” lists parameters across different sectors of the network node, identified as “ALPHA,” “BETA,” “GAMMA,” with corresponding ECGI IDs for each. These are unique identifiers for each sector, enabling precise management and reporting. Additional columns labelled “ALPHA ADDITIONAL” and “GAMMA ADDITIONAL” imply the capability to display extra data points or configurations for those sectors.

The placeholders and fields in the interface indicate a customizable and dynamic tool designed to adapt to a variety of data inputs and provide network administrators with comprehensive control over the monitoring and configuration of network nodes. The interface encapsulates detailed node information, from basic identification and geographic location to intricate sector-specific parameters, promoting efficient network management practices.

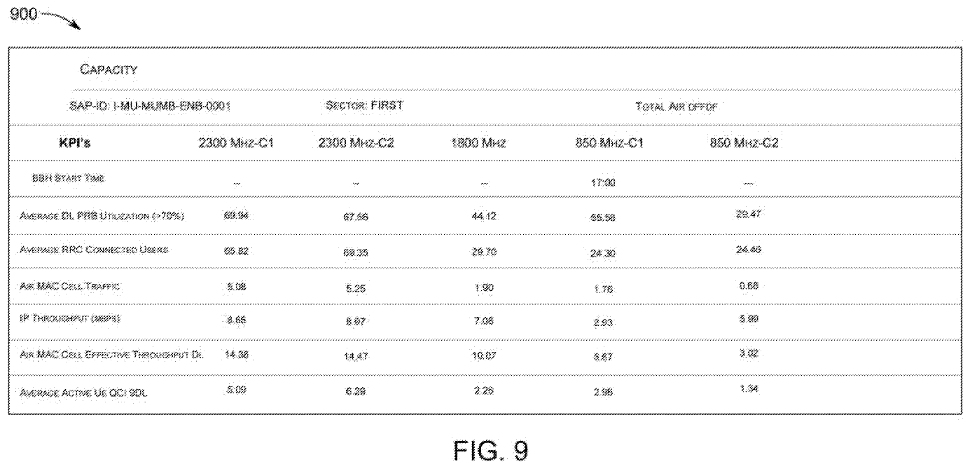

FIG. 9 illustrates an exemplary capacity view 900, in accordance with an embodiment of the disclosure. FIG. 9 provides a tabulated display of Key Performance Indicators (KPIs) for a cellular network node with the identifier “SAP-ID: I-MU-MUMB-ENB-0001,” categorized by frequency band and sector as part of the system's capacity assessment module.

The table is segmented into columns representing different frequency bands for the sector named “FIRST.” These bands are “2300 MHz-C1,” “2300 MHZ-C2,” “1800 MHZ,” “850 MHZ-C1,” and “850 MHZ-C2.” An additional column titled “TOTAL AIR DFDF” is likely a summation or average of the KPIs across all listed bands.

The KPIs displayed in the table include metrics such as “AVERAGE DL PRB UTILIZATION (>70%),” indicating the average downlink Physical Resource Block utilization exceeding 70%, a measure of bandwidth efficiency. The values across the frequency bands provide insight into resource usage with bands such as “2300 MHz-C1” showing a utilization of “69.94” which can imply a percentage or another unit of measure.

“AVERAGE RRC CONNECTED USERS” reflects the average number of users connected via the Radio Resource Control protocol, which is critical for understanding user density and network load.

The “AIR MAC CELL TRAFFIC” row can represent the average traffic over the air interface, measured at the Medium Access Control (MAC) sub-layer of the cell. It is presented in values that may denote the number of users or a traffic volume metric.

“IP THROUGHPUT (MBPS)” is straightforward in indicating the average data throughput of the Internet Protocol layer, provided in megabits per second (Mbps), which is key to evaluating the data handling capacity of the network.

“AIR MAC CELL EFFECTIVE THROUGHPUT DL” and “AVERAGE ACTIVE UE QCI 9DL” likely measure specific aspects of throughput and Quality of Service (QOS) for active users, specifically for non-guaranteed bit rate data streams denoted by QCI (QOS Class Identifier) value “9” in the downlink direction.

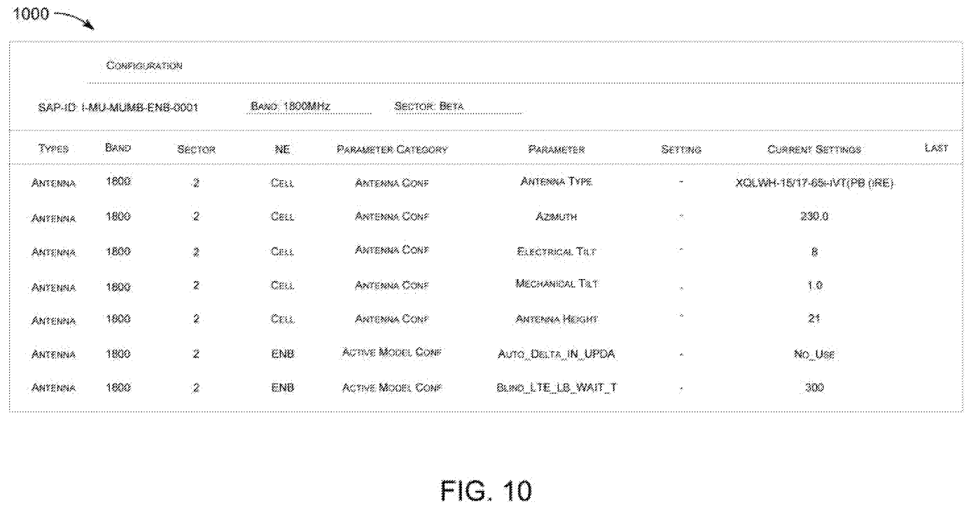

FIG. 10 illustrates an exemplary configuration view, in accordance with an embodiment of the disclosure. FIG. 10 displays a configuration interface 1000, outlining various settings for a telecommunications network node. The table is part of a system used to detail and adjust the operational parameters of network antennas within a specific sector.

The header of the interface indicates “SAP-ID: I-MU-MUMB-ENB-0008” and specifies the frequency band as “1800 MHZ,” which the configurations below pertain to. The sector is identified as “BETA,” signifying that the data corresponds to this particular segment of the node.

The table is arranged into columns that categorize the network elements. Each row is labeled “ANTENNA,” associated with the “1800 MHZ” band of the “BETA” sector. The “NE” column, which stands for Network Element, specifies the element as “CELL” for the majority of the entries, indicating these settings are relevant to the cell level.

The “PARAMETER CATEGORY” and “PARAMETER” columns list the specific antenna configuration parameters being managed. These include “Antenna Type,” “Azimuth,” “Electrical Tilt,” “Mechanical Tilt,” and “Antenna Height,” each critical for defining the physical orientation and characteristics of the antenna to optimize signal propagation and network coverage.

The final two rows categorize under “ACTIVE MODEL CONF,” which likely relate to dynamic operational configurations of the network base station, denoted as “ENB.” These settings include “AUTO_DELTA_IN_UPDA” and “BLIND_LTE_LB_WAIT_T,” which can be automated algorithms or thresholds for network adjustments like load balancing or signal handover timings.

The “CURRENT SETTINGS” column is poised to display the actual values for each parameter, with one visible entry showing an azimuth setting of “230.0,” likely indicating the angle in degrees relative to true north.

The disclosed system and method display the spider menu in the UI for accessing various dimensions related to the sites. The dimensions may be related to such as Project Management, the KPI, the capacity metrics, and site properties. A visualization framework may be provided for showing PM KPI, FM alarms, properties, capacity, configuration for the cellular wireless nodes.

The disclosed system and method provide an improved mechanism of visualizing all the key metrics for the cellular wireless nodes using a spider view menu that provides a maximum observability with a single click. As all critical information is available under the same database and the data is fetched from the pre-processed databases, the manual effort to visit multiple URLs, and logins is reduced. Further, quick availability of the reports like alarms, KPIs, and configuration may eradicate complexity of work.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

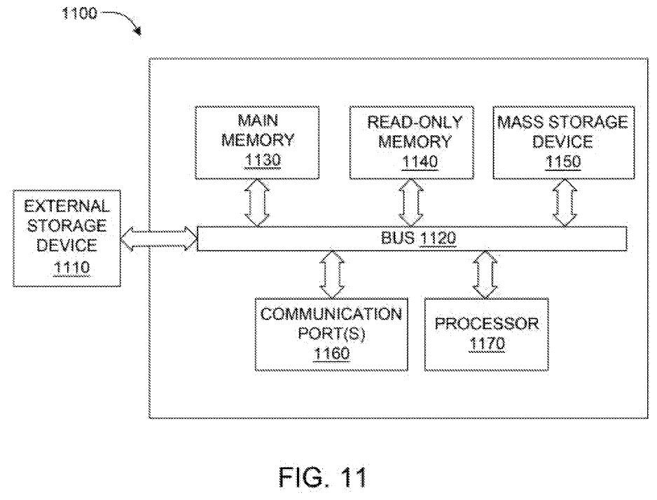

FIG. 11 illustrates an exemplary computer system 1100 in which or with which embodiments of the present disclosure may be implemented.

As shown in FIG. 11, the computer system 1100 may include an external storage device 1110, a bus 1120, a main memory 1130, a read-only memory 1140, a mass storage device 1150, communication port(s) 1160, and a processor 1170. A person skilled in the art will appreciate that the computer system 1100 may include more than one processor and communication ports. The processor 1170 may include various modules associated with embodiments of the present disclosure. The communication port(s) 1160 may be any of an RS-232 port for use with a modem-based dialup connection, a 10/100 Ethernet port, a Gigabit or 10 Gigabit port using copper or fiber, a serial port, a parallel port, or other existing or future ports. The communication port(s) 1160 may be chosen depending on a network, such a Local Area Network (LAN), Wide Area Network (WAN), or any network to which the computer system 1100 connects. The main memory 1130 may be random access memory (RAM), or any other dynamic storage device commonly known in the art. The read-only memory 1140 may be any static storage device(s) including, but not limited to, a Programmable Read Only Memory (PROM) chips for storing static information e.g., start-up or basic input/output system (BIOS) instructions for the processor 1170. The mass storage device 1150 may be any current or future mass storage solution, which may be used to store information and/or instructions.

The bus 1120 communicatively couples the processor 1170 with the other memory, storage, and communication blocks. The bus 1120 can be, e.g. a Peripheral Component Interconnect (PCI)/PCI Extended (PCI-X) bus, Small Computer System Interface (SCSI), universal serial bus (USB), or the like, for connecting expansion cards, drives, and other subsystems as well as other buses, such a front side bus (FSB), which connects the processor 1170 to the computer system 1100.

Optionally, operator and administrative interfaces, e.g., a display, keyboard, and a cursor control device, may also be coupled to the bus 1120 to support direct operator interaction with the computer system 1100. Other operator and administrative interfaces may be provided through network connections connected through the communication port(s) 1160. In no way should the aforementioned exemplary computer system 1100 limit the scope of the present disclosure.

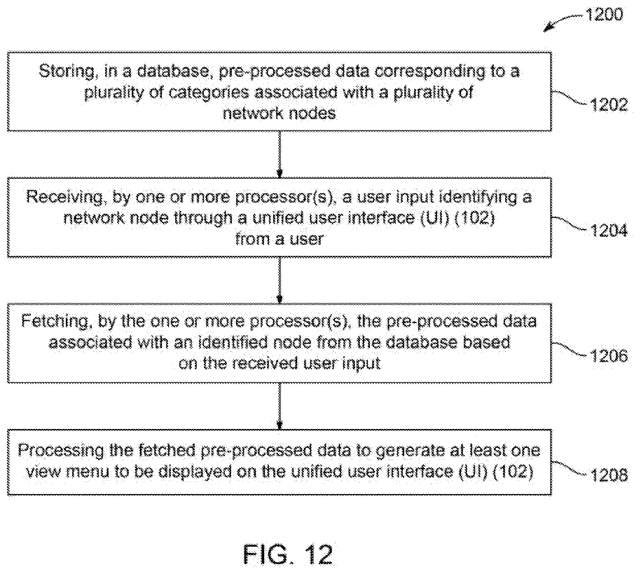

FIG. 12 illustrates an exemplary flow chart showing a method (1200) for visualizing and managing data associated with network nodes in a telecommunication network, in accordance with an embodiment of the disclosure.

At step 1202, the system is configured to store pre-processed data corresponding to a plurality of categories associated with a plurality of network nodes in a database.

At step 1204, the one or more processor(s) are configured to receive a user input identifying a network node through a unified user interface (UI) from a user. In an aspect, the step 1204 further includes identifying the network node through a search functionality within the unified UI based on at least one of geographical information, a hardware vendor, or an operating server.

At step 1206, the one or more processor(s) are configured to fetch the pre-processed data associated with an identified node from the database based on the received user input.

At step 1208, the one or more processor(s) are configured to process the fetched pre-processed data to generate at least one view menu to be displayed on the unified user interface (UI). In an aspect, the at least one generated view menu is a spider view menu comprising a plurality of segments, each segment corresponding to each category of the plurality of categories of the pre-processed data. The method further includes a step of generating, on the unified UI, a visual representation of the pre-processed data in each segment of the spider view menu, wherein the visual representation is differentiated by color codes based on a category of pre-processed data and a type of network node.

In an aspect, the method further includes a step of enabling, through the unified UI, a one-click access to fetch a detailed information associated with the plurality of categories of the pre-processed data to the user avoiding additional logins to multiple applications and updating, by the one or more processor(s), the spider view menu in real-time based on updates to the pre-processed data in the database. The method further includes managing, by one or more processor(s), an interaction of the pre-processed data across multiple types of the plurality of network nodes, hardware vendors, and operating servers in a synchronized manner.

In an aspect, the spider view menu further comprises interactive elements configured to navigate to sub-categories of data within each segment.

In an aspect, the method further includes aggregating, by the one or more processor(s), historical data associated with the alarms category to display an alarm history for the identified node within an alarms segment of the spider view menu. The method further includes comparing, by one or more processor(s), one or more key performance indicators (KPIs) across different cells of the identified node to provide cell-level comparisons within a KPIs segment.

In an exemplary embodiment, the present disclosure discloses a user equipment which is configured to visualize and manage data associated with network nodes in a telecommunication network. The user equipment includes a processor, and a computer readable storage medium storing programming instructions for execution by the processor. Under the programming instructions, the processor is configured to store pre-processed data corresponding to a plurality of categories associated with a plurality of network nodes. Under the programming instructions, the processor is configured to receive a user input identifying a network node through a unified user interface (UI) from a user. Under the programming instructions, the processor is configured to fetch the pre-processed data associated with an identified node based on the received user input. Under the programming instructions, the processor is configured to process the fetched pre-processed data to generate at least one view menu to be displayed on the unified user interface (UI).

In an aspect, the at least one generated view menu is a spider view menu comprising a plurality of segments, each segment corresponding to each category of the plurality of categories of the pre-processed data.

In an aspect, the processor is further configured to generate a visual representation of the pre-processed data in each segment of the spider view menu on the unified user interface (UI). The visual representation is differentiated by colour codes based on a category of pre-processed data and a type of network node.

The method and system of the present disclosure may be implemented in a number of ways. For example, the methods and systems of the present disclosure may be implemented by software, hardware, firmware, or any combination of software, hardware, and firmware. The above-described order for the steps of the method is for illustration only, and the steps of the method of the present disclosure are not limited to the order specifically described above unless specifically stated otherwise. Further, in some embodiments, the present disclosure may also be embodied as programs recorded in a recording medium, the programs including machine-readable instructions for implementing the methods according to the present disclosure. Thus, the present disclosure also covers a recording medium storing a program for executing the method according to the present disclosure.

While considerable emphasis has been placed herein on the preferred embodiments, it will be appreciated that many embodiments can be made and that many changes can be made in the preferred embodiments without departing from the principles of the disclosure. These and other changes in the preferred embodiments of the disclosure will be apparent to those skilled in the art from the disclosure herein, whereby it is to be distinctly understood that the foregoing descriptive matter to be implemented merely as illustrative of the disclosure and not as limitation.

### ADVANTAGES OF THE PRESENT DISCLOSURE

The present disclosure provides a system and a method to use a spider view menu to provide data visualization for information related to wireless cellular network nodes of a cellular network.

The present disclosure provides a User Interface (UI) for showing all node specific information on single click.

The present disclosure eliminates a user's requirement to navigate multiple Uniform resource Locators (URLs) and perform multiple logins to access and view relevant metrics information from multiple vendors.

The present disclosure provides an easy identification of KPI performance check using a KPI comparison.

The present disclosure provides a maximum observability of the site using the pre-processed data.

1. A method of visualizing and managing data associated with network nodes in a telecommunication network, the method comprising:
storing, in a database, a pre-processed data corresponding to a plurality of categories associated with a plurality of network nodes;
receiving, by one or more processor(s), a user input identifying a network node through a unified user interface (UI) from a user;
fetching, by the one or more processor(s), the pre-processed data associated with an identified node from the database based on the received user input; and
processing, by the one or more processor(s), the fetched pre-processed data to generate at least one view menu to be displayed on the unified user interface (UI).

2. The method of claim 1, wherein the at least one generated view menu is a spider view menu comprising a plurality of segments, each segment corresponding to each category of the plurality of categories of the pre-processed data.

3. The method of claim 1, further comprising:
generating, on the unified UI, a visual representation of the pre-processed data in each segment of the spider view menu, wherein the visual representation is differentiated by color codes based on a category of pre-processed data and a type of network node.

4. The method of claim 2, further comprising:
enabling, through the unified UI, a one-click access to fetch a detailed information associated with the plurality of categories of the pre-processed data to the user avoiding additional logins to multiple applications;
updating, by the one or more processor(s), the spider view menu in real-time based on updates to the pre-processed data in the database; and
managing, by the one or more processor(s), an interaction of the pre-processed data across multiple types of the plurality of network nodes, hardware vendors, and operating servers in a synchronized manner.

5. The method of claim 1, wherein the step of receiving user input further comprises identifying the network node through a search functionality within the unified UI based on at least one of a geographical information, a hardware vendor, or an operating server.

6. The method of claim 1, wherein the spider view menu further comprises interactive elements configured to navigate to sub-categories of data within each segment.

7. The method of claim 1, further comprising:
aggregating, by the one or more processor(s), a historical data associated with alarms category to display an alarm history for the identified node within an alarms segment of the spider view menu; and
comparing, by the one or more processor(s), one or more key performance indicators (KPIs) across different cells of the identified node to provide cell level comparisons within a KPIs segment.

8. (canceled)

9. A system for visualizing and managing data associated with network nodes in a telecommunication network, the system comprising:
a database configured to store pre-processed data corresponding to a plurality of categories associated with a plurality of network nodes; and
one or more processors configured to receive a user input identifying a network node through a unified user interface (UI) from a user;
the one or more processors are further configured to:
fetch the pre-processed data associated with an identified node based on the received user input; and
process the fetched pre-processed data to generate at least one view menu to be displayed on the unified user interface (UI).

10. The system of claim 9, wherein the at least one generated view menu is a spider view menu comprising a plurality of segments, each segment corresponding to each category of the plurality of categories of the pre-processed data.

11. The system of claim 10, wherein the one or more processors are further configured to generate a visual representation of the pre-processed data in each segment of the spider view menu on the unified user interface (UI), wherein the visual representation is differentiated by colour codes based on a category of pre-processed data and a type of network node.

12. The system of claim 9, wherein the one or more processors are further configured to:
enable a one-click access, through the unified UI, to fetch a detailed information associated with the plurality of categories of the pre-processed data to the user avoiding additional logins to multiple applications;
update the spider view menu in real-time based on real-time updates to the pre-processed data in the database; and
manage an interaction of the pre-processed data across multiple types of the plurality of network nodes, hardware vendors, and operating servers in a synchronized manner.

13. The system of claim 9, wherein the plurality of segments is selected from a group consisting of an alarms segment, a key performance indicators (KPIs) segment, a properties segment, a capacity segment, and a configuration segment.

14. The system of claim 9, wherein the one or more processors are further configured to identify the network node through a search functionality within the unified UI based on at least one of a geographical information, a hardware vendor, or an operating server.

15. The system of claim 9, wherein the spider view menu further includes a plurality of interactive elements configured to navigate to sub-categories of pre-processed data within each segment.

16. The system of claim 9, wherein the one or more processors are further configured to:
aggregate historical data associated with the alarms category to display an alarm history for the identified network node within the alarms segment of the spider view menu; and
compare one or more key performance indicators (KPIs) across different network cells of the identified node to provide cell level comparisons within the KPIs segment.

17. The system of claim 9, wherein the pre-processed data includes a cell level properties data and a site level properties data.

18. The system of claim 9, wherein the unified UI is further configured to display an inventory information, backhaul data, and antenna details within a properties segment of the spider view menu.

19. A user equipment configured to visualize and manage data associated with network nodes in a telecommunication network, the user equipment comprising:
a processor; and
a computer readable storage medium storing programming for execution by the processor, the programming including instructions to:
store pre-processed data corresponding to a plurality of categories associated with a plurality of network nodes;
receive a user input identifying a network node through a unified user interface (UI) from a user;
fetch the pre-processed data associated with an identified node based on the received user input; and
process the fetched pre-processed data to generate at least one view menu to be displayed on the unified user interface (UI).

20. (canceled)

21. (canceled)

22. A computer program product comprising a non-transitory computer-readable medium comprising instructions that, when executed by one or more processors, cause the one or more processors to perform:
store, in a database, pre-processed data corresponding to a plurality of categories associated with a plurality of network nodes;
receive a user input identifying a network node through a unified user interface (UI) from a user;
fetch the pre-processed data associated with an identified node based on the received user input; and
process the fetched pre-processed data to generate at least one view menu to be displayed on the unified user interface (UI).
